(19) United States
(12) Patent Application Publication
(10) Pub. No.: US 2025/0377773 A1
(43) Pub. Date: Dec. 11, 2025

(54) PERFORMING TASKS BASED ON SELECTED OBJECTS IN A THREE-DIMENSIONAL SCENE

(71) Applicant: Apple Inc., Cupertino, CA (US)

(72) Inventor: Evan JONES, Kirkland, WA (US)

(21) Appl. No.: 19/213,157

(22) Filed: May 20, 2025

Related U.S. Application Data
(60) Provisional application No. 63/657,031, filed on Jun. 6, 2024.

(51) Int. Cl. G06F 3/04842; G06F 3/01; G06F 3/16

(52) U.S. Cl. CPC G06F 3/04842; G06F 3/013; G06F 3/017; G06F 3/167

(57) ABSTRACT

An example process includes: concurrently detecting: a first natural language input that requests to perform a first task and a first input that corresponds to a selection of a first object; in response to concurrently detecting the first natural language input and the first input, initiating the first task based on the first object; and after initiating the first task based on the first object: detecting a second input corresponding to a selection of a second object different from the first object; and in response to detecting the second input corresponding to the selection of the second object: in accordance with a determination that the second input satisfies a set of input criteria, initiating, without receiving a natural language input after detecting the first natural language input, the first task based on the second object.

### CROSS-REFERENCE TO RELATED APPLICATIONS

This application claims priority to U.S. Patent Application No. 63/657,031, entitled “PERFORMING TASKS BASED ON SELECTED OBJECTS IN A THREE-DIMENSIONAL SCENE,” filed on Jun. 6, 2024, the entire content of which is hereby incorporated by reference in its entirety.

### TECHNICAL FIELD

The present disclosure relates to performing tasks based on user-selected objects in a three-dimensional scene.

### BACKGROUND

The development of computer systems for interacting with and/or providing three-dimensional scenes has expanded significantly in recent years. Example three-dimensional scenes (e.g., environments) include physical scenes and extended reality scenes.

### SUMMARY

Example methods are disclosed herein. An example method includes: at a computer system that is in communication with a microphone and one or more sensor devices: concurrently detecting: a first natural language input via the microphone, wherein the first natural language input requests to perform a first task; and a first input via the one or more sensor devices, wherein the first input corresponds to a selection of a first object, and wherein the first input is different from the first natural language input; in response to concurrently detecting the first natural language input and the first input, initiating the first task based on the first object; and after initiating the first task based on the first object: detecting, via the one or more sensor devices, a second input corresponding to a selection of a second object different from the first object; and in response to detecting, via the one or more sensor devices, the second input corresponding to the selection of the second object different from the first object: in accordance with a determination that the second input satisfies a set of input criteria, initiating, without receiving a natural language input after detecting the first natural language input, the first task based on the second object different from the first object.

Example non-transitory computer-readable storage media are disclosed herein. An example non-transitory computer-readable storage medium stores one or more programs. The one or more programs are configured to be executed by one or more processors of a computer system that is in communication with a microphone and one or more sensor devices. The one or more programs include instructions for: concurrently detecting: a first natural language input via the microphone, wherein the first natural language input requests to perform a first task; and a first input via the one or more sensor devices, wherein the first input corresponds to a selection of a first object, and wherein the first input is different from the first natural language input; in response to concurrently detecting the first natural language input and the first input, initiating the first task based on the first object; and after initiating the first task based on the first object: detecting, via the one or more sensor devices, a second input corresponding to a selection of a second object different from the first object; and in response to detecting, via the one or more sensor devices, the second input corresponding to the selection of the second object different from the first object: in accordance with a determination that the second input satisfies a set of input criteria, initiating, without receiving a natural language input after detecting the first natural language input, the first task based on the second object different from the first object.

Example computer systems are disclosed herein. An example computer system is configured to communicate with a microphone and one or more sensor devices. The computer system comprises: one or more processors; and memory storing one or more programs configured to be executed by the one or more processors, the one or more programs including instructions for: concurrently detecting: a first natural language input via the microphone, wherein the first natural language input requests to perform a first task; and a first input via the one or more sensor devices, wherein the first input corresponds to a selection of a first object, and wherein the first input is different from the first natural language input; in response to concurrently detecting the first natural language input and the first input, initiating the first task based on the first object; and after initiating the first task based on the first object: detecting, via the one or more sensor devices, a second input corresponding to a selection of a second object different from the first object; and in response to detecting, via the one or more sensor devices, the second input corresponding to the selection of the second object different from the first object: in accordance with a determination that the second input satisfies a set of input criteria, initiating, without receiving a natural language input after detecting the first natural language input, the first task based on the second object different from the first object.

An example computer system is configured to communicate with a microphone and one or more sensor devices. The computer system comprises: means for concurrently detecting: a first natural language input via the microphone, wherein the first natural language input requests to perform a first task; and a first input via the one or more sensor devices, wherein the first input corresponds to a selection of a first object, and wherein the first input is different from the first natural language input; means, in response to concurrently detecting the first natural language input and the first input, for initiating the first task based on the first object; means, after initiating the first task based on the first object, for detecting, via the one or more sensor devices, a second input corresponding to a selection of a second object different from the first object; and means, after initiating the first task based on the first object and in response to detecting, via the one or more sensor devices, the second input corresponding to the selection of the second object different from the first object and in accordance with a determination that the second input satisfies a set of input criteria, for initiating, without receiving a natural language input after detecting the first natural language input, the first task based on the second object different from the first object.

Initiating the first task based on the second object in the manner described herein and when certain conditions are met may allow a computer system to accurately and efficiently initiate a previously requested task based on a newly selected object. In this manner, the user-device interface is made more accurate and efficient (e.g., by reducing the number of user inputs required to operate the device as desired, by avoiding redundant user inputs, by helping the device perform user-intended operations, and by avoiding user inputs otherwise required to cease unwanted operations and/or to undo the results of unwanted operations), which additionally reduces power usage and improves battery life of the device by enabling the user to use the device more quickly and efficiently.

In some examples, the computer system is a desktop computer with an associated display. In some examples, the computer system is a portable device (e.g., a notebook computer, tablet computer, or handheld device such as a smartphone). In some examples, the computer system is a personal electronic device (e.g., a wearable electronic device, such as a watch or a head-mounted device). In some examples, the computer system has a touchpad. In some examples, the computer system has one or more cameras. In some examples, the computer system has a display generation component (e.g., a display device such as a head-mounted display, a display, a projector, a touch-sensitive display (also known as a “touch screen” or “touch-screen display”), or other device or component that presents visual content to a user, for example on or in the display generation component itself or produced from the display generation component and visible elsewhere). In some examples, the computer system does not have a display generation component and does not present visual content to a user. In some examples, the computer system has a touch-sensitive display (also known as a “touch screen” or “touch-screen display”). In some examples, the computer system has one or more eye-tracking components. In some examples, the computer system has one or more hand-tracking components. In some examples, the computer system has one or more output devices, the output devices including one or more tactile output generators and/or one or more audio output devices. In some examples, the computer system has one or more processors, memory, and one or more modules, programs or sets of instructions stored in the memory for performing various functions described herein. In some examples, the user interacts with the computer system through a stylus and/or finger contacts and gestures on the touch-sensitive surface, movement of the user's eyes and hand in space or the user's body as captured by cameras and other movement sensors, and/or voice inputs as captured by one or more audio input devices. Executable instructions for performing these functions are, optionally, included in a transitory and/or non-transitory computer-readable storage medium or other computer program product configured for execution by one or more processors.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 is a block diagram illustrating an operating environment of a computer system for interacting with three-dimensional (3D) scenes, according to some examples.

FIG. 2 is a block diagram of a user-facing component of the computer system, according to some examples.

FIG. 3 is a block diagram of a controller of the computer system, according to some examples.

FIG. 4 illustrates an architecture for a foundation model, according to some examples.

FIGS. 5A-5H and FIGS. 6A-6E illustrate a device performing tasks based on user-selected objects that are present in a three-dimensional scene, according to some examples.

FIG. 7 is a flow diagram of a method for performing tasks based on user-selected objects that are present in a three-dimensional scene, according to some examples.

### DETAILED DESCRIPTION

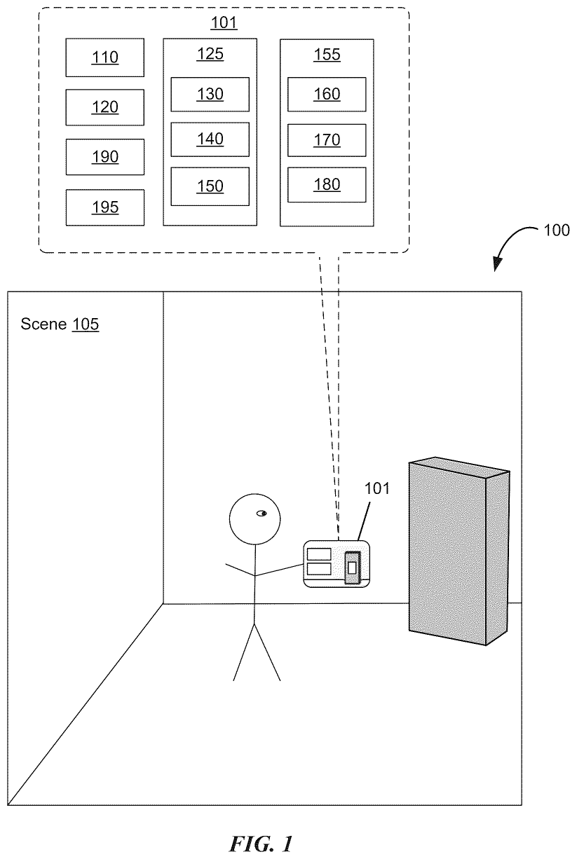

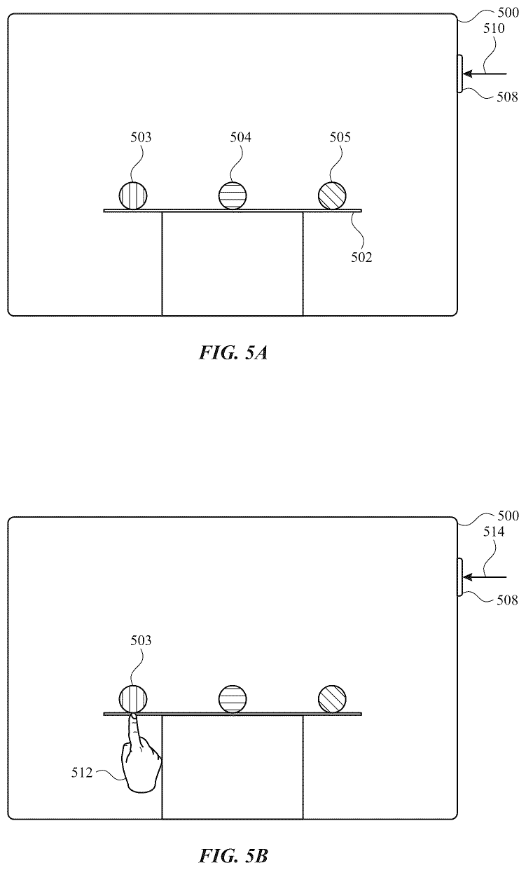

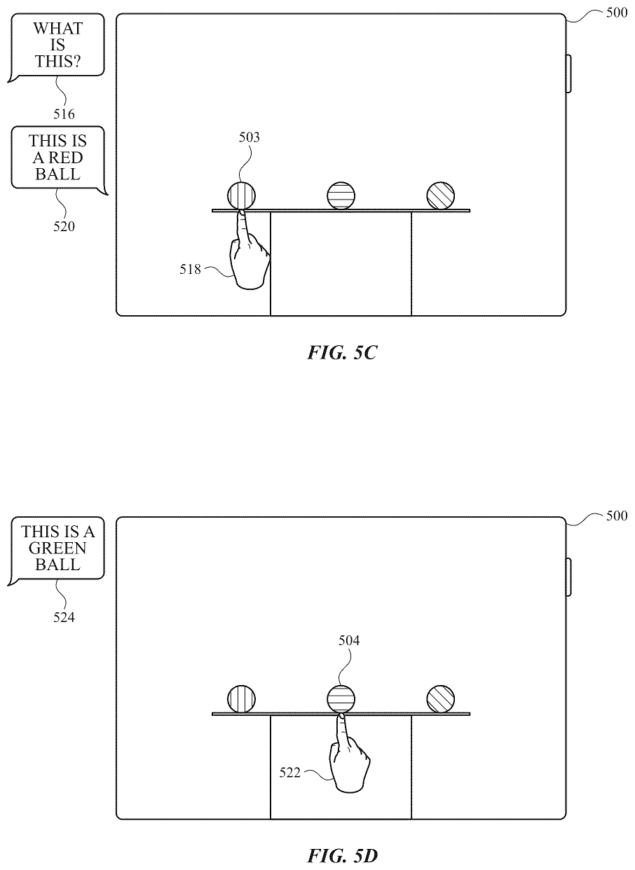

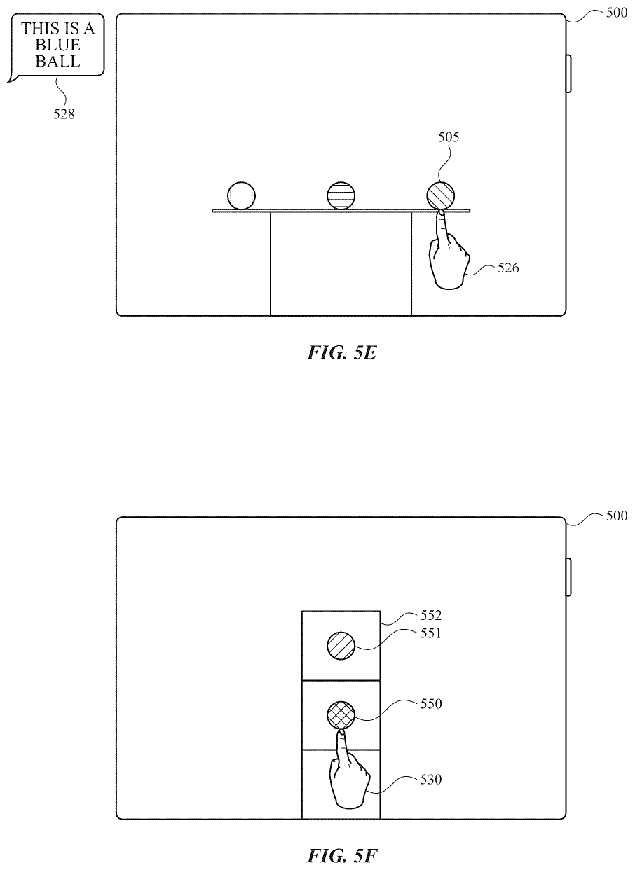

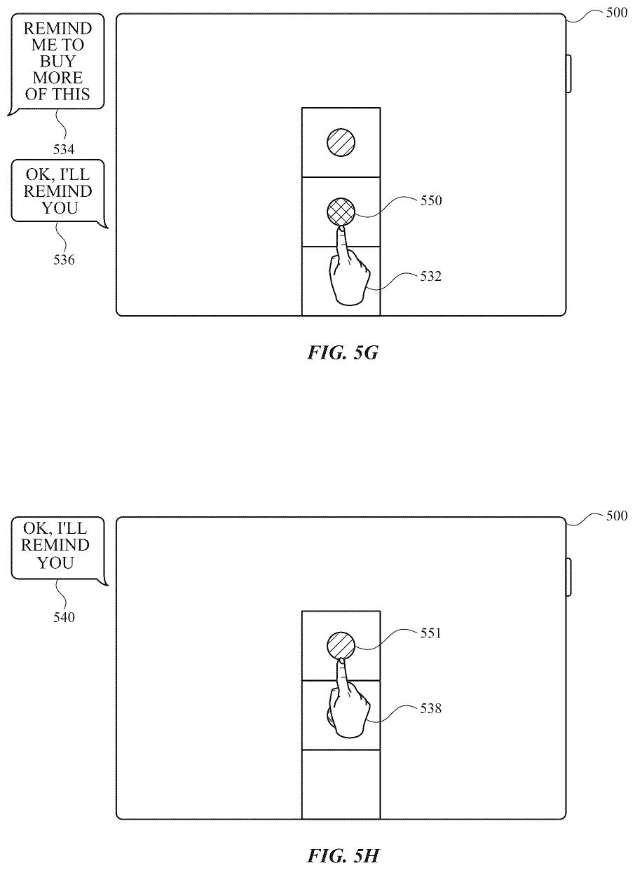

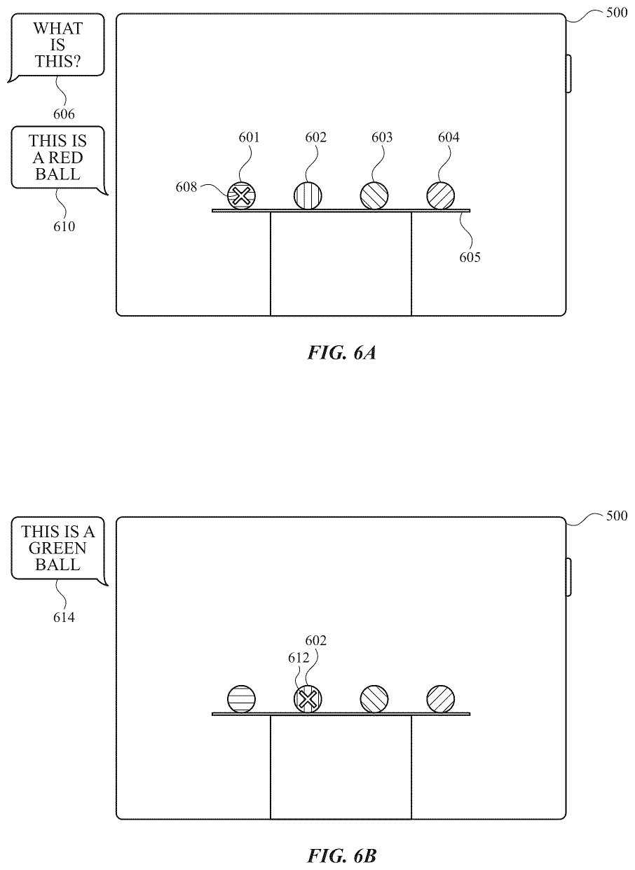

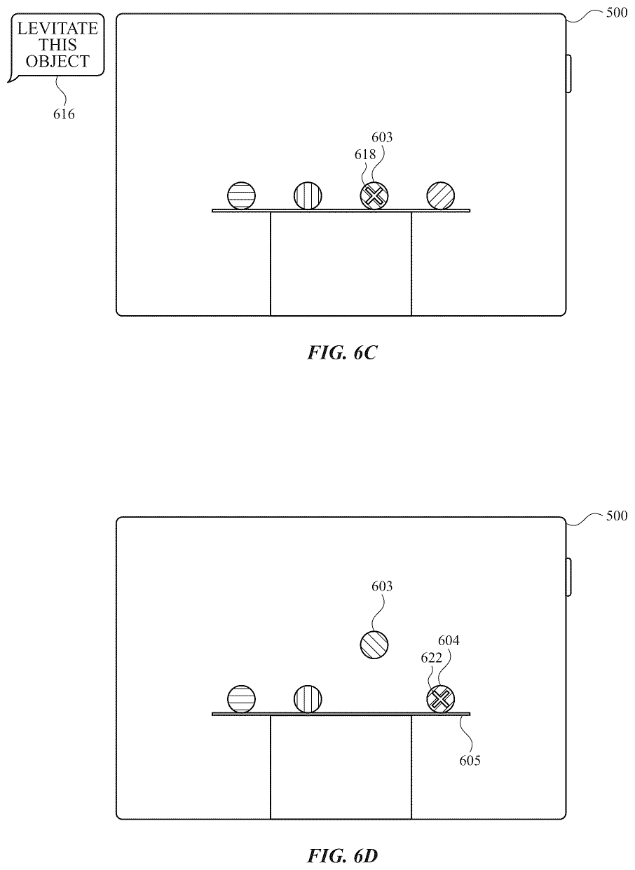

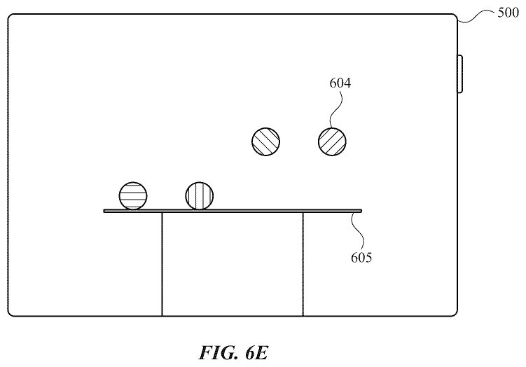

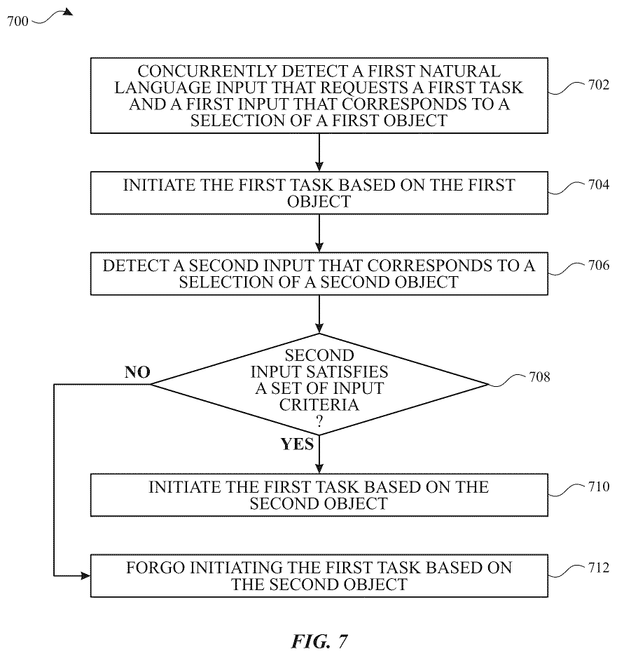

FIGS. 1-4 provide a description of example computer systems and techniques for interacting with three-dimensional scenes. FIGS. 5A-5H and 6A-6E illustrate a device performing tasks based on user-selected objects that are present in a three-dimensional scene. FIG. 7 is a flow diagram of a method for performing tasks based on user-selected objects that are present in a three-dimensional scene. FIGS. 5A-5H and 6A-6E are used to illustrate the processes in FIG. 7.

In addition, in methods described herein where one or more steps are contingent upon one or more conditions having been met, it should be understood that the described method can be repeated in multiple repetitions so that over the course of the repetitions, all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer-readable medium claims where the system or computer-readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer-readable storage medium can repeat the steps of a method as many times as are needed to ensure that all of the contingent steps have been performed.

FIG. 1 is a block diagram illustrating an operating environment of computer system 101 for interacting with three-dimensional scenes, according to some examples. In FIG. 1, a user interacts with three-dimensional scene 105 via operating environment 100 that includes computer system 101. In some examples, computer system 101 includes controller 110 (e.g., processors of a portable electronic device or a remote server), user-facing component 120, one or more input devices 125 (e.g., eye tracking device 130, hand tracking device 140, and/or other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, audio sensors, etc.), and one or more peripheral devices 195 (e.g., home appliances, wearable devices, etc.). In some examples, one or more of input devices 125, output devices 155, sensors 190, and peripheral devices 195 are integrated with user-facing component 120 (e.g., in a head-mounted device or a handheld device).

While pertinent features of the operating environment 100 are shown in FIG. 1, those of ordinary skill in the art will appreciate from the present disclosure that various other features have not been illustrated for the sake of brevity and so as not to obscure more pertinent aspects of the examples disclosed herein.

Hardware: There are many different types of electronic systems that enable a person to sense and/or interact with three-dimensional scenes. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). Alternatively, a head-mounted system may be configured to operate without displaying content, e.g., so that the head-mounted system provides output to a user via tactile and/or auditory means. The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one example, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

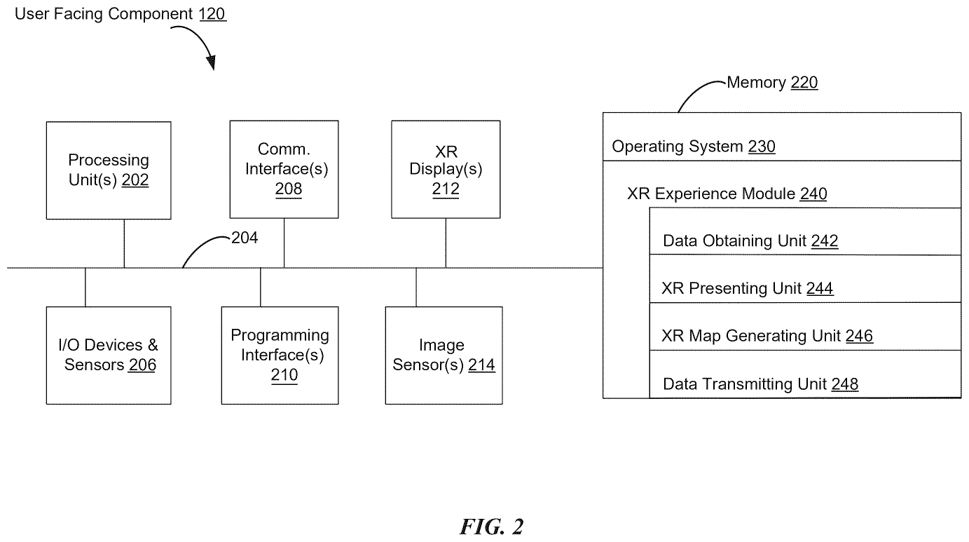

In some examples, user-facing component 120 is configured to provide a visual component of a three-dimensional scene. In some examples, user-facing component 120 includes a suitable combination of software, firmware, and/or hardware. User-facing component 120 is described in greater detail below with respect to FIG. 2. In some examples, the functionalities of controller 110 are provided by and/or combined with user-facing component 120. In some examples, user-facing component 120 provides an extended reality (XR) experience to the user while the user is virtually and/or physically present within scene 105.

In some examples, user-facing component 120 is worn on a part of the user's body (e.g., on his/her head, on his/her hand, etc.). In some examples, user-facing component 120 includes one or more XR displays provided to display the XR content. In some examples, user-facing component 120 encloses the field-of-view of the user. In some examples, user-facing component 120 is a handheld device (such as a smartphone or tablet) configured to present XR content, and the user holds the device with a display directed towards the field-of-view of the user and a camera directed towards the scene 105. In some examples, the handheld device is optionally placed within an enclosure that is worn on the head of the user. In some examples, the handheld device is optionally placed on a support (e.g., a tripod) in front of the user. In some examples, user-facing component 120 is an XR chamber, enclosure, or room configured to present XR content in which the user does not wear or hold user-facing component 120. Many user interfaces described with reference to one type of hardware for displaying XR content (e.g., a handheld device or a device on a tripod) could be implemented on another type of hardware for displaying XR content (e.g., a head-mounted device (HMD) or other wearable computing device). For example, a user interface showing interactions with XR content triggered based on interactions that happen in a space in front of a handheld or tripod-mounted device could similarly be implemented with an HMD where the interactions happen in a space in front of the HMD and the responses of the XR content are displayed via the HMD. Similarly, a user interface showing interactions with XR content triggered based on movement of a handheld or tripod-mounted device relative to the physical environment (e.g., scene 105 or a part of the user's body (e.g., the user's eye(s), head, or hand)) could similarly be implemented with an HMD where the movement is caused by movement of the HMD relative to the physical environment (e.g., scene 105 or a part of the user's body (e.g., the user's eye(s), head, or hand)).

FIG. 2 is a block diagram of user-facing component 120, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 2 is intended more as a functional description of the various features that could be present in a particular implementation as opposed to a structural schematic of the examples described herein. As recognized by those of ordinary skill in the art, components shown separately could be combined and some components could be separated. For example, some functional modules shown separately in FIG. 2 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, user-facing component 120 (e.g., HMD) includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 210, one or more XR displays 212, one or more optional interior-and/or exterior-facing image sensors 214, a memory 220, and one or more communication buses 204 for interconnecting these and various other components.

In some examples, one or more communication buses 204 include circuitry that interconnects and controls communications between system components. In some examples, one or more I/O devices and sensors 206 include at least one of an inertial measurement unit (IMU), an accelerometer, a gyroscope, a thermometer, one or more biometric sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, one or more XR displays 212 are configured to provide an XR experience to the user. In some examples, one or more XR displays 212 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some examples, one or more XR displays 212 correspond to diffractive, reflective, polarized, holographic, etc. waveguide displays. For example, user-facing component 120 (e.g., HMD) includes a single XR display. In another example, user-facing component 120 includes an XR display for each eye of the user. In some examples, one or more XR displays 212 are capable of presenting XR content. In some examples, one or more XR displays 212 are omitted from user-facing component 120. For example, user-facing component 120 does not include any component that is configured to display content (or does not include any component that is configured to display XR content) and user-facing component 120 provides output via audio and/or haptic output types.

In some examples, one or more image sensors 214 are configured to obtain image data that corresponds to at least a portion of the face of the user that includes the eyes of the user (and may be referred to as an eye-tracking camera). In some examples, one or more image sensors 214 are configured to obtain image data that corresponds to at least a portion of the user's hand(s) and optionally arm(s) of the user (and may be referred to as a hand-tracking camera). In some examples, one or more image sensors 214 are configured to be forward-facing to obtain image data that corresponds to the scene as would be viewed by the user if user-facing component 120 (e.g., HMD) was not present (and may be referred to as a scene camera). One or more optional image sensors 214 can include one or more RGB cameras (e.g., with a complementary metal-oxide-semiconductor (CMOS) image sensor or a charge-coupled device (CCD) image sensor), one or more infrared (IR) cameras, one or more event-based cameras, and/or the like.

Memory 220 includes high-speed random-access memory, such as DRAM, SRAM, DDR RAM, or other random-access solid-state memory devices. In some examples, memory 220 includes non-volatile memory, such as one or more magnetic disk storage devices, optical disk storage devices, flash memory devices, or other non-volatile solid-state storage devices. Memory 220 optionally includes one or more storage devices remotely located from the one or more processing units 202. Memory 220 comprises a non-transitory computer-readable storage medium. In some examples, memory 220 or the non-transitory computer-readable storage medium of memory 220 stores the following programs, modules and data structures, or a subset thereof, including optional operating system 230 and XR experience module 240.

Operating system 230 includes instructions for handling various basic system services and for performing hardware dependent tasks. In some examples, XR experience module 240 is configured to present XR content to the user via one or more XR displays 212 or one or more speakers. To that end, in various examples, XR experience module 240 includes data obtaining unit 242, XR presenting unit 244, XR map generating unit 246, and data transmitting unit 248.

In some examples, data obtaining unit 242 is configured to obtain data (e.g., presentation data, interaction data, sensor data, location data, etc.) from at least controller 110 of FIG. 1. To that end, in various examples, data obtaining unit 242 includes instructions and/or logic therefor, and heuristics and metadata therefor.

In some examples, XR presenting unit 244 is configured to present XR content via one or more XR displays 212 or more or more speakers. To that end, in various examples, XR presenting unit 244 includes instructions and/or logic therefor, and heuristics and metadata therefor.

In some examples, XR map generating unit 246 is configured to generate an XR map (e.g., a 3D map of the extended reality scene or a map of the physical environment into which computer-generated objects can be placed) based on media content data. To that end, in various examples, XR map generating unit 246 includes instructions and/or logic therefor, and heuristics and metadata therefor.

In some examples, the data transmitting unit 248 is configured to transmit data (e.g., presentation data, location data, sensor data, etc.) to at least controller 110, and optionally one or more of input devices 125, output devices 155, sensors 190, and/or peripheral devices 195. To that end, in various examples, data transmitting unit 248 includes instructions and/or logic therefor, and heuristics and metadata therefor.

Although data obtaining unit 242, XR presenting unit 244, XR map generating unit 246, and data transmitting unit 248 are shown as residing on a single device (e.g., user-facing component 120 of FIG. 1), in other examples, any combination of data obtaining unit 242, XR presenting unit 244, XR map generating unit 246, and data transmitting unit 248 may reside on separate computing devices.

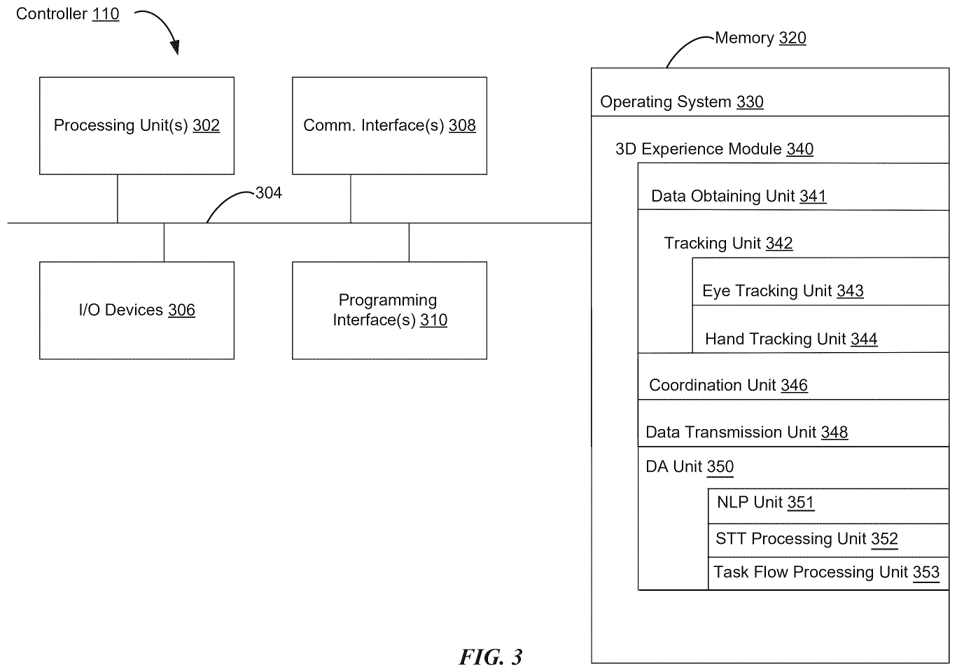

Returning to FIG. 1, controller 110 is configured to manage and coordinate a user's experience with respect to a three-dimensional scene. In some examples, controller 110 includes a suitable combination of software, firmware, and/or hardware. Controller 110 is described in greater detail below with respect to FIG. 3.

In some examples, controller 110 is a computing device that is local or remote relative to scene 105 (e.g., a physical environment). For example, controller 110 is a local server located within scene 105. In another example, controller 110 is a remote server located outside of scene 105 (e.g., a cloud server, central server, etc.). In some examples, controller 110 is communicatively coupled with the component(s) of computer system 101 that are configured to provide output to the user (e.g., output devices 155 and/or user-facing component 120) via one or more wired or wireless communication channels (e.g., BLUETOOTH, IEEE 802.11x, IEEE 802.16x, IEEE 802.3x, etc.). In some examples, controller 110 is included within the enclosure (e.g., a physical housing) of the component(s) of computer system 101 that are configured to provide output to the user (e.g., user-facing component 120) or shares the same physical enclosure or support structure with the component(s) of computer system 101 that are configured to provide output to the user.

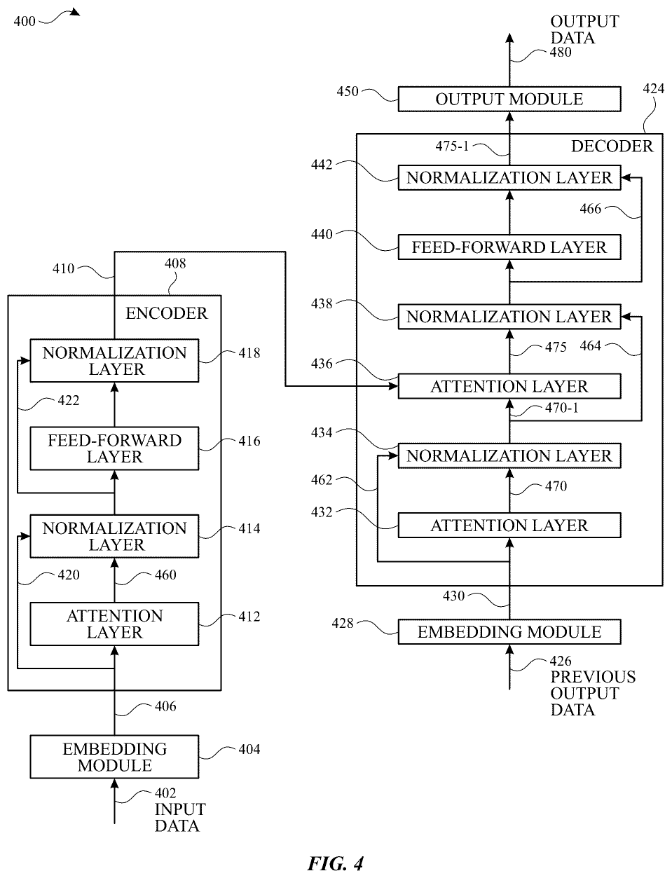

In some examples, the various components and functions of controller 110 described below with respect to FIGS. 3-4 are distributed across multiple devices. For example, a first set of the components of controller 110 (and their associated functions) are implemented on a server system remote to scene 105 while a second set of the components of controller 110 (and their associated functions) are local to scene 105. For example, the second set of components are implemented within a portable electronic device (e.g., a wearable device such as an HMD) that is present within scene 105. It will be appreciated that the particular manner in which the various components and functions of controller 110 are distributed across various devices can vary based on different implementations of the examples described herein.

FIG. 3 is a block diagram of a controller 110, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 3 is intended more as a functional description of the various features that may be present in a particular implementation as opposed to a structural schematic of the examples described herein. As recognized by those of ordinary skill in the art, components shown separately could be combined and some components could be separated. For example, some functional modules shown separately in FIG. 3 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, controller 110 includes one or more processing units 302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 306, one or more communication interfaces 308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 310, memory 320, and one or more communication buses 304 for interconnecting these and various other components.

In some examples, one or more communication buses 304 include circuitry that interconnects and controls communications between system components. In some examples, one or more I/O devices 306 include at least one of a keyboard, a mouse, a touchpad, a joystick, one or more microphones, one or more speakers, one or more image sensors, one or more displays, and/or the like.

Memory 320 includes high-speed random-access memory, such as dynamic random-access memory (DRAM), static random-access memory (SRAM), double-data-rate random-access memory (DDR RAM), or other random-access solid-state memory devices. In some examples, memory 320 includes non-volatile memory, such as one or more magnetic disk storage devices, optical disk storage devices, flash memory devices, or other non-volatile solid-state storage devices. Memory 320 optionally includes one or more storage devices remotely located from the one or more processing units 302. Memory 320 comprises a non-transitory computer-readable storage medium. In some examples, memory 320 or the non-transitory computer-readable storage medium of memory 320 stores the following programs, modules and data structures, or a subset thereof, including an optional operating system 330 and three-dimensional (3D) experience module 340.

Operating system 330 includes instructions for handling various basic system services and for performing hardware dependent tasks.

In some examples, three-dimensional (3D) experience module 340 is configured to manage and coordinate the user experience provided by computer system 101 with respect to a three-dimensional scene. For example, 3D experience module 340 is configured to obtain data corresponding to the three-dimensional scene (e.g., data generated by computer system 101 and/or data from data obtaining unit 341 discussed below) to cause computer system 101 to perform actions for the user (e.g., provide suggestions, display content, etc.) based on the data. To that end, in various examples, 3D experience module 340 includes data obtaining unit 341, tracking unit 342, coordination unit 346, data transmission unit 348, and digital assistant (DA) unit 350.

In some examples, data obtaining unit 341 is configured to obtain data (e.g., presentation data, interaction data, sensor data, location data, etc.) from one or more of user-facing component 120, input devices 125, output devices 155, sensors 190, and peripheral devices 195. To that end, in various examples, data obtaining unit 341 includes instructions and/or logic therefor, and heuristics and metadata therefor.

In some examples, tracking unit 342 is configured to map scene 105 and to track the position/location of the user (and/or of a portable device being held or worn by the user). To that end, in various examples, tracking unit 342 includes instructions and/or logic therefor, and heuristics and metadata therefor.

In some examples, tracking unit 342 includes eye tracking unit 343. Eye tracking unit 343 includes instructions and/or logic for tracking the position and movement of the user's gaze (or more broadly, the user's eyes, face, or head) using data obtained from eye tracking device 130. In some examples, eye tracking unit 343 tracks the position and movement of the user's gaze relative to a physical environment, relative to the user (e.g., the user's hand, face, or head), relative to a device worn or held by the user, and/or relative to content displayed by user-facing component 120.

Eye tracking device 130 is controlled by eye tracking unit 343 and includes various hardware and/or software components configured to perform eye tracking techniques. For example, eye tracking device 130 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards mirrors that reflect IR or NIR light from the eyes to the eye tracking cameras. Eye tracking device 130 optionally captures images of the user's eyes (e.g., as a video stream captured at 60-120 frames per second), analyzes the images to generate eye tracking information, and communicates the eye tracking information to eye tracking unit 343. In some examples, two eyes of the user are separately tracked by respective eye tracking cameras and illumination sources. In some examples, only one eye of the user is tracked by a respective eye tracking camera and illumination sources.

In some examples, tracking unit 342 includes hand tracking unit 344. Hand tracking unit 344 includes instructions and/or logic for tracking, using hand tracking data obtained from hand tracking device 140, the position of one or more portions of the user's hands and/or motions of one or more portions of the user's hands. Hand tracking unit 344 tracks the position and/or motion relative to scene 105, relative to the user (e.g., the user's head, face, or eyes), relative to a device worn or held by the user, relative to content displayed by user-facing component 120, and/or relative to a coordinate system defined relative to the user's hand. In some examples, hand tracking unit 344 analyzes the hand tracking data to identify a hand gesture (e.g., a pointing gesture, a pinching gesture, a clenching gesture, and/or a grabbing gesture) and/or to identify content (e.g., physical content or virtual content) corresponding to the hand gesture, e.g., content selected by the hand gesture. In some examples, a hand gesture is an air gesture. An air gesture is a gesture that is detected without the user touching (or independently of) an input element that is part of a device (e.g., computer system 101, one or more input devices 125, hand tracking device 140, and/or device 500) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

Hand tracking device 140 is controlled by hand tracking unit 344 and includes various hardware and/or software components configured to perform hand tracking and hand gesture recognition techniques. For example, hand tracking device 140 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 140 communicates the temporal sequence of the hand tracking data to hand tracking unit 344 for further analysis, e.g., to identify hand gestures, hand poses, and/or hand movements.

In some examples, hand tracking device 140 includes one or more hardware input devices configured to be worn and/or held by (or be otherwise attached to) one or more respective hands of the user. In such examples, hand tracking unit 344 tracks the position, pose, and/or motion of a user's hand based on tracking the position, pose, and/or motion of the respective hardware input device. Hand tracking unit 344 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch-sensitive surface(s), pressure-sensitive surface(s), knob(s), joystick(s), and the like). In some examples, instead of, or in addition to, performing a particular function in response to detecting a respective type of hand gesture, computer system 101 analogously performs the particular function in response to a user input that selects a respective physical control of the hardware input device. For example, computer system 101 interprets a pinching hand gesture input as a selection of an in-focus element and/or interprets selection of a physical button of the hardware device as a selection of the in-focus element.

In some examples, coordination unit 346 is configured to manage and coordinate the experience provided to the user via user-facing component 120, one or more output devices 155, and/or one or more peripheral devices 195. To that end, in various examples, coordination unit 346 includes instructions and/or logic therefor, and heuristics and metadata therefor.

In some examples, data transmission unit 348 is configured to transmit data (e.g., presentation data, location data, etc.) to user-facing component 120, one or more input devices 125, output devices 155, sensors 190, and/or peripheral devices 195. To that end, in various examples, data transmission unit 348 includes instructions and/or logic therefor, and heuristics and metadata therefor.

Digital assistant (DA) unit 350 includes instructions and/or logic for providing DA functionality to computer system 101. DA unit 350 therefore provides a user of computer system 101 with DA functionality while they and/or their avatar are present in a three-dimensional scene. For example, the DA performs various tasks related to the three-dimensional scene, either proactively or upon request from the user. In some examples, DA unit 350 performs at least some of: converting speech input into text (e.g., using speech-to-text (STT) processing unit 352); identifying a user's intent expressed in a natural language input received from the user; actively eliciting and obtaining information needed to fully satisfy the user's intent (e.g., by disambiguating terms in the natural language input and/or by obtaining information from data obtaining unit 341); determining a task flow for fulfilling the identified intent; and executing the task flow to fulfill the identified intent.

In some examples, DA unit 350 includes natural language processing (NLP) unit 351 configured to identify the user intent. NLP unit 351 takes the n-best candidate text representation(s) (word sequence(s) or token sequence(s)) generated by STT processing unit 352 and attempts to associate each of the candidate text representations with one or more user intents recognized by the DA. In some examples, a user intent represents a task that can be performed by the DA and has an associated task flow implemented in task flow processing unit 353. The associated task flow is a series of programmed actions and steps that the DA takes in order to perform the task. The scope of a DA's capabilities is, in some examples, dependent on the number and variety of task flows that are implemented in task flow processing unit 353, or in other words, on the number and variety of user intents the DA recognizes.

In some examples, once NLP unit 351 identifies a user intent based on the user request, NLP unit 351 causes task flow processing unit 353 to perform the actions required to satisfy the user request. For example, task flow processing unit 353 executes the task flow corresponding to the identified user intent to perform a task to satisfy the user request. In some examples, performing the task includes causing computer system 101 to provide output (e.g., graphical, audio, and/or haptic output) indicating the performed task.

DA unit 350 is configured to perform tasks based on user-selected objects in a three-dimensional scene. Specifically, in conjunction with data obtaining unit 341 and tracking unit 342, DA unit 350 is configured to perform a task based on detected natural language input and other detected input (e.g., gaze input and/or gesture input) that selects an object, e.g., a physical object or a virtual object. Examples of the task include providing information about the object (e.g., for natural language inputs such as “where does this go?” or “how much money is this?”), identifying the object (e.g., for the natural language input “what is this?”), and/or performing another action based on the object (e.g., “move this to the right,” “remove this,” or “add this to my shopping list”). In some examples, DA unit 350 is configured to set computer system 101 into a continuous object selection session. During the continuous object selection session, computer system 101 initiates, based on a previously received natural language input that requests a task, respective instances of the same task based on respective different objects selected by respective different user inputs. In some examples, DA unit 350 is configured to cause computer system 101 to exit the continuous context session. The aforementioned functionalities of DA unit 350 are discussed in greater detail below with respect to FIGS. 5A-5H and 6A-6E.

In some examples, 3D experience module 340 accesses one or more artificial intelligence (AI) models that are configured to perform various functions described herein. The AI model(s) are at least partially implemented on controller 110 (e.g., implemented locally on a single device, or implemented in a distributed manner) and/or controller 110 communicates with one or more external services that provide access to the AI model(s). In some examples, one or more components and functions of DA unit 350 are implemented using the AI model(s). For example, speech-to-text processing unit 352 and natural language processing unit 351 implement separate respective AI models to facilitate and/or perform speech recognition and natural language processing, respectively.

In some examples, the AI model(s) are based on (e.g., are, or are constructed from) one or more foundation models. Generally, a foundation model is a deep learning neural network that is trained based on a large training dataset and that can adapt to perform a specific function. Accordingly, a foundation model aggregates information learned from a large (and optionally, multimodal) dataset and can adapt to (e.g., be fine-tuned to) perform various downstream tasks that the foundation model may not have been originally designed to perform. Examples of such tasks include language translation, speech recognition, user intent determination (e.g., natural language processing), sentiment analysis, computer vision tasks (e.g., object recognition and scene understanding), question answering, image generation, audio generation, and generation of computer-executable instructions. Foundation models can accept a single type of input (e.g., text data) or accept multimodal input, such as two or more of text data, image data, video data, audio data, sensor data, and the like. In some examples, a foundation model is prompted to perform a particular task by providing it with a natural language description of the task. Example foundation models include the GPT-n series of models (e.g., GPT-1, GPT-2, GPT-3, and GPT-4), DALL-E, and CLIP from Open AI, Inc., Florence and Florence-2 from Microsoft Corporation, BERT from Google LLC, and LLAMA, LLaMA-2, and LLaMA-3 from Meta Platforms, Inc.

FIG. 4 illustrates architecture 400 for a foundation model, according to some examples. Architecture 400 is merely exemplary and various modifications to architecture 400 are possible. Accordingly, the components of architecture 400 (and their associated functions) can be combined, the order of the components (and their associated functions) can be changed, components of architecture 400 can be removed, and other components can be added to architecture 400. Further, while architecture 400 is transformer-based, one of skill in the art will understand that architecture 400 can additionally or alternatively implement other types of machine learning models, such as convolutional neural network (CNN)-based models and recurrent neural network (RNN)-based models.

Architecture 400 is configured to process input data 402 to generate output data 480 that corresponds to a desired task. Input data 402 includes one or more types of data, e.g., text data, image data, video data, audio data, sensor (e.g., motion sensor, biometric sensor, temperature sensor, and the like) data, computer-executable instructions, structured data (e.g., in the form of an XML file, a JSON file, or another file type), and the like. In some examples, input data 402 includes data from data obtaining unit 341. Output data 480 includes one or more types of data that depend on the task to be performed. For example, output data 480 includes one or more of: text data, image data, audio data, and computer-executable instructions. It will be appreciated that the above-described input and output data types are merely exemplary and that architecture 400 can be configured to accept various types of data as input and generate various types of data as output. Such data types can vary based on the particular function the foundation model is configured to perform.

Architecture 400 includes embedding module 404, encoder 408, embedding module 428, decoder 424, and output module 450, the functions of which are now discussed below.

Embedding module 404 is configured to accept input data 402 and parse input data 402 into one or more token sequences. Embedding module 404 is further configured to determine an embedding (e.g., a vector representation) of each token that represents each token in embedding space, e.g., so that similar tokens have a closer distance in embedding space and dissimilar tokens have a further distance. In some examples, embedding module 404 includes a positional encoder configured to encode positional information into the embeddings. The respective positional information for an embedding indicates the embedding's relative position in the sequence. Embedding module 404 is configured to output embedding data 406 of the input data by aggregating the embeddings for the tokens of input data 402.

Encoder 408 is configured to map embedding data 406 into encoder representation 410. Encoder representation 410 represents contextual information for each token that indicates learned information about how each token relates to (e.g., attends to) each other token. Encoder 408 includes attention layer 412, feed-forward layer 416, normalization layers 414 and 418, and residual connections 420 and 422. In some examples, attention layer 412 applies a self-attention mechanism on embedding data 406 to calculate an attention representation (e.g., in the form of a matrix) of the relationship of each token to each other token in the sequence. In some examples, attention layer 412 is multi-headed to calculate multiple different attention representations of the relationship of each token to each other token, where each different representation indicates a different learned property of the token sequence. Attention layer 412 is configured to aggregate the attention representations to output attention data 460 indicating the cross-relationships between the tokens from input data 402. In some examples, attention layer 412 further masks attention data 460 to suppress data representing the relationships between select tokens. Encoder 408 then passes (optionally masked) attention data 460 through normalization layer 414, feed-forward layer 416, and normalization layer 418 to generate encoder representation 410. Residual connections 420 and 422 can help stabilize and shorten the training and/or inference process by respectively allowing the output of embedding module 404 (i.e., embedding data 406) to directly pass to normalization layer 414 and allowing the output of normalization layer 414 to directly pass to normalization layer 418.

While FIG. 4 illustrates that architecture 400 includes a single encoder 408, in other examples, architecture 400 includes multiple stacked encoders configured to output encoder representation 410. Each of the stacked encoders can generate different attention data, which may allow architecture 400 to learn different types of cross-relationships between the tokens and generate output data 410 based on a more complete set of learned relationships.

Decoder 424 is configured to accept encoder representation 410 and previous output embedding 430 as input to generate output data 480. Embedding module 428 is configured to generate previous output embedding 430. Embedding module 428 is similar to embedding module 404. Specifically, embedding module 428 tokenizes previous output data 426 (e.g., output data 480 that was generated by the previous iteration), determines embeddings for each token, and optionally encodes positional information into each embedding to generate previous output embedding 430.

Decoder 424 includes attention layers 432 and 436, normalization layers 434, 438, and 442, feed-forward layer 440, and residual connections 462, 464, and 466. Attention layer 432 is configured to output attention data 470 indicating the cross-relationships between the tokens from previous output data 426. Attention layer 432 is similar to attention layer 412. For example, attention layer 432 applies a multi-headed self-attention mechanism on previous output embedding 430 and optionally masks attention data 470 to suppress data representing the relationships between select tokens (e.g., the relationship(s) between a token and future token(s)) so architecture 400 does not consider future tokens as context when generating output data 480. Decoder 424 then passes (optionally masked) attention data 470 through normalization layer 434 to generate normalized attention data 470-1.

Attention layer 436 accepts encoder representation 410 and normalized attention data 470-1 as input to generate encoder-decoder attention data 475. Encoder-decoder attention data 475 correlates input data 402 to previous output data 426 by representing the relationship between the output of encoder 408 and the previous output of decoder 424. Attention layer 436 allows decoder 424 to increase the weight of the portions of encoder representation 410 that are learned as more relevant to generating output data 480. In some examples, attention layer 436 applies a multi-headed attention mechanism to encoder representation 410 and to normalized attention data 470-1 to generate encoder-decoder attention data 475. In some examples, attention layer 436 further masks encoder-decoder attention data 475 to suppress the cross-relationships between select tokens.

Decoder 424 then passes (optionally masked) encoder-decoder attention data 475 through normalization layer 438, feed-forward layer 440, and normalization layer 442 to generate further-processed encoder-decoder attention data 475-1. Normalization layer 442 then provides further-processed encoder-decoder attention data 475-1 to output module 450. Similar to residual connections 420 and 422, residual connections 462, 464, and 466 may stabilize and shorten the training and/or inference process by allowing the output of a corresponding component to directly pass as input to a corresponding component.

While FIG. 4 illustrates that architecture 400 includes a single decoder 424, in other examples, architecture 400 includes multiple stacked decoders each configured to learn/generate different types of encoder-decoder attention data 475. This allows architecture 400 to learn different types of cross-relationships between the tokens from input data 402 and the tokens from output data 480, which may allow architecture 400 to generate output data 480 based on a more complete set of learned relationships.

Output module 450 is configured to generate output data 480 from further-processed encoder-decoder attention data 475-1. For example, output module 450 includes one or more linear layers that apply a learned linear transformation to further-processed encoder-decoder attention data 475-1 and a softmax layer that generates a probability distribution over the possible classes (e.g., words or symbols) of the output tokens based on the linear transformation data. Output module 450 then selects (e.g., predicts) an element of output data 480 based on the probability distribution. Architecture 400 then passes output data 480 as previous input data 426 to embedding module 428 to begin another iteration of the training and/or inference process for architecture 400.

It will be appreciated that various different AI models can be constructed based on the components of architecture 400. For example, some large language models (LLMs) (e.g., GPT-2 and GPT-3) are decoder-only (e.g., include one or more instances of decoder 424 and do not include encoder 408), some LLMs (e.g., BERT) are encoder-only (include one or more instances of encoder 408 and do not include decoder 424), and other foundation models (e.g., Florence-2) are encoder-decoder (e.g., include one or more instances of encoder 408 and include one or more instances of decoder 424). Further, it will be appreciated that the foundation models constructed based on the components of architecture 400 can be fine-tuned based on reinforcement learning techniques and training data specific to a particular task for optimization for the particular task, e.g., extracting relevant semantic information from image and/or video data, generating code, generating music, providing suggestions relevant to a specific user, and the like.

FIGS. 5A-5H and 6A-6E illustrate device 500 performing tasks based on user-selected objects that are present in a three-dimensional scene, according to some examples.

FIGS. 5A-5H and 6A-6E illustrate a user's view of respective three-dimensional scenes. In some examples, device 500 provides at least a portion of the scenes of FIGS. 5A-5H and 6A-6E. For example, the scenes are XR scenes that include at least some virtual elements generated by device 500. In other examples, the scenes are physical scenes.

Device 500 implements at least some of the components of computer system 101. For example, device 500 includes one or more sensors configured to detect data (e.g., image data and/or audio data) corresponding to the respective scenes. In some examples, device 500 is an HMD (e.g., an XR headset or smart glasses) and FIGS. 5A-5H and 6A-6E illustrate the user's view of the respective scenes via the HMD. For example, 5A-5H and 6A-6E illustrate physical scenes viewed via pass-through video, physical scenes viewed via direct optical see-through, or virtual scenes viewed via one or more displays of the HMD. In other examples, device 500 is another type of device, such as a smart watch, a smart phone, a tablet device, a laptop computer, a projection-based device, or a pair of headphones or earbuds.

The examples of FIGS. 5A-5H and 6A-6E illustrate that the user and device 500 are present within the respective scenes. For example, the scenes are physical or extended reality scenes and the user and device 500 are physically present within the scenes. In other examples, an avatar of the user is present within the scenes. For example, when the scenes are virtual reality scenes, the avatar of the user is present within the virtual reality scenes.

In FIG. 5A, the scene includes table 502 with objects 503, 504, and 505 on top of table 502. In FIG. 5A, device 500 is not set to a gesture recognition mode. When device 500 is not set to the gesture recognition mode, device 500 does not detect hand gestures performed by a user of device 500 and/or does not perform operations based on the detected hand gestures. For example, when device 500 is not set to the gesture recognition mode, hand tracking device 140 is disabled (e.g., does not detect data) and/or device 500 does not execute instructions (e.g., instructions included in hand tracking device 140 and/or hand tracking unit 344) to process data detected by hand tracking device 140. In FIG. 5A, device 500 detects input 510 that selects hardware button 508 of device 500.

In response to detecting input 510, device 500 is set to a gesture recognition mode. When device 500 is set to the gesture recognition mode, device 500 detects hand gestures performed by a user of device 500 and performs actions based on the detected hand gestures if the hand gestures satisfy certain conditions, as discussed below. When device 500 is set to the gesture recognition mode, hand tracking device 140 is enabled (e.g., detects hand tracking data) and device 500 executes instructions (e.g., contained in hand tracking device 140 and/or hand tracking unit 344) to process the hand tracking data. While FIGS. 5A-5B describe setting device 500 to a gesture recognition mode via a selection of hardware button 508, in other examples, device 500 receives another type of input (e.g., speech input, input received via a peripheral device, input that moves device 500 in a predetermined manner, gaze input, and/or input that selects a graphical element) to set device 500 to the gesture recognition mode. In other examples, device 500 is set to the gesture recognition mode whenever device 500 is powered on, or device 500 is set, by default, to the gesture recognition mode whenever device 500 is powered on.

In some examples, device 500 is set to the gesture recognition mode for a predetermined duration (e.g., 10 seconds, 15 seconds, 30 seconds, or 1 minute). In some examples, the predetermined duration starts from when device 500 is set to the gesture recognition mode and the predetermined duration (e.g., a timer for the predetermined duration) resets each time device 500 detects a hand gesture. In some examples, if the predetermined duration elapses (e.g., the predetermined duration has elapsed since device 500 was set to the gesture recognition mode or the predetermined duration has elapsed since device 500 last detected a hand gesture), device 500 exits the gesture recognition mode.

In FIG. 5B, the predetermined duration for the gesture recognition mode has elapsed, so device 500 is no longer in a gesture recognition mode. In FIG. 5B, the user performs hand gesture 512 that selects object 503. Because device 500 is not in the gesture recognition mode, device 500 does not perform any operation based on hand gesture 512. In FIG. 5B, after the user performs hand gesture 512, device 500 receives input 514 that selects hardware button 508. In response to receiving input 514, device 500 re-initiates the gesture recognition mode. The gesture recognition mode is initiated in FIGS. 5C-5H below.

In FIG. 5C, device 500 concurrently detects speech input 516 “what is this?” and hand gesture input 518 that selects object 503. For example, device 500 detects hand gesture input 518 while detecting at least a portion of speech input 516, e.g., detects hand gesture input 518 at a time that is between the start and end times of speech input 516. In some examples, device 500 detects speech input 516 and hand gesture input 518 within a predetermined duration (e.g., 0.1 seconds, 0.2 seconds, 0.5 seconds, or 1 second) of each other, e.g., such that the detection time of speech input 516 and the detection time of hand gesture input 518 fall within the predetermined duration. In the examples discussed herein, the operations performed in response to concurrently detecting an object selection input (e.g., inputs 518, 532, 608, and 618 that correspond to selection of respective objects) and a natural language input (e.g., speech inputs 516, 534, 606, and 616) are alternatively performed in response to detecting the object selection input and the natural language input within a predetermined duration of each other.

In FIG. 5C, in response to concurrently detecting speech input 516 and hand gesture input 518, device 500 performs, based on selected object 503, the task requested by speech input 516. Specifically, device 500 identifies object 503 and provides audio output 520 “this is a red ball.”

In FIG. 5C, in response to concurrently detecting speech input 516 and hand gesture input 518, device 500 further initiates a continuous object selection session. As detailed below with respect to FIGS. 5D-5E, during the continuous object selection session, device 500 selectively performs, without detecting natural language input further to speech input 516, respective instances of the task requested by speech input 516 based on respective objects (e.g., 504 and 505) selected by respective user inputs (e.g., 522 and 526).

In FIG. 5D, while the continuous object selection session is initiated (e.g., remains active) on device 500, device 500 detects hand gesture input 522 that selects object 504. In response to detecting hand gesture input 522, if hand gesture input 522 satisfies one or more input criteria, device 500 performs, based on selected object 504, the task requested by speech input 516. If hand gesture input 522 does not satisfy certain input criteria, device 500 forgoes performing the task.

Example input criteria are now discussed. In some examples, an input criterion is satisfied when the type of hand gesture input 522 matches a type of hand gesture input 518. For example, hand gesture input 522 satisfies the input criterion because hand gesture input 522 and hand gesture input 518 are both hand gestures and/or are both the same type of hand gesture (e.g., both a pointing gesture, both a one-finger pointing gesture, both a two-finger pointing gesture, both a gesture performed while the corresponding hand is open, both a gesture performed while the corresponding hand is closed, both a gesture that present respective objects to one or more image sensors of device 500, and the like). In some examples, an input criterion is satisfied when hand gesture input 522 corresponds to a selection of object 504. Accordingly, in some examples, device 500 does not require hand gesture input 522 to be of the same type as hand gesture input 518 to perform the task based on selected object 504. Rather, to perform the task, device 500 determines that hand gesture input 522 (or another type of input) is a selection of object 504. In some examples, an input criterion is satisfied when hand gesture input 522 is detected before a predetermined duration elapses. In some examples, the predetermined duration is the predetermined duration for the gesture recognition mode, as discussed above with respect to FIGS. 5A-5B. In some examples, the predetermined duration is a predetermined duration for which the continuous object selection session remains active (is not exited) on device 500. In some examples, an input criterion is satisfied when hand gesture input 522 is detected while device 500 is set to a hand gesture recognition mode. In some examples, an input criterion is satisfied when hand gesture input 522 is received while the continuous object selection session is initiated (e.g., is active) on device 500. In some examples, an input criterion is satisfied when object 503 and object 504 are determined to be similar objects, e.g., the same type of object. For example, device 500 (e.g., using DA unit 350) classifies objects 503 and 504 into respective types (e.g., based on shape, size, identity, and/or location) and the input criterion is satisfied when objects 503 and 504 are the same type of object, e.g., are both small objects, are both spherical objects, and/or are both placed on the same surface. As another example, device 500 prompts an AI model (e.g., as discussed above with respect to FIG. 4) to determine a score (e.g., a binary score) representing the similarity between objects 503 and 504 and the input criterion is satisfied when the similarity score is above a threshold score, or when the similarity score is a threshold value (e.g., 1). In some examples, an input criterion is satisfied when speech input 516 is determined to be relevant to object 504. For example, device 500 (e.g., using DA unit 350) determines a relevancy score (e.g., a score between 0 and 1 or a binary score) that represents the relevance of speech input 516 to object 504 and the input criterion is satisfied when the relevancy score exceeds a threshold score or when the relevancy score is a predetermined value, e.g., 1. In some examples, device 500 determines the relevancy score by prompting an AI model to determine the relevancy score, e.g., as discussed above with respect to FIG. 4. It will be appreciated that the particular set of input criteria that is satisfied for device 500 to perform the task (and similarly the particular set of input criteria that is not satisfied for device 500 to forgo performing the task) can vary across different implementations of the examples discussed herein.

In FIG. 5D, hand gesture input 522 satisfies the set of input criteria. Thus, in response to detecting hand gesture input 522, device 500 performs, based on selected object 504, the task requested by previous speech input 516. Specifically, device 500 identifies object 504 and provides audio output 524 “this is a green ball.”

In FIG. 5E, while the continuous object selection session remains initiated on device 500, device 500 detects hand gesture input 526 that selects object 505. Hand gesture input 526 satisfies the input criteria discussed above. Thus, in response to detecting hand gesture input 526, device 500 performs, based on selected object 505, the task requested by previous speech input 516. Specifically, device 500 identifies object 505 and provides audio output 528 “this is a blue ball.”

In FIG. 5F, device 500 exits the continuous object selection session. Device 500 exits the continuous object selection session if a set of session exit criteria are satisfied, as discussed below. In some examples, a session exit criterion is satisfied when a predetermined duration has elapsed from when device 500 last detected a gesture, e.g., a hand gesture. For example, the continuous object selection session remains active for a predetermined duration (e.g., 10 seconds, 15 seconds, 30 seconds, or 1 minute) after initiation (e.g., in FIG. 5C) and the predetermined duration resets when device 500 detects an object selection input. For example, in FIG. 5F, device 500 exits the continuous object selection session because hand gesture input 526 of FIG. 5E was the last detected hand gesture and the predetermined duration has elapsed from when device 500 detected hand gesture input 526. In some examples, an exit criterion is satisfied based on detected image data that represents a scene. For example, device 500 analyzes image data to determine whether the image data represents greater than a threshold amount of change to a current scene. If the image data represents greater than the threshold amount of change to the current device, device 500 exits the continuous object selection session. For example, the scene of FIG. 5F has changed by greater than a threshold amount relative to the scene of FIG. 5E (e.g., because the user walked to a different room of a house that includes objects 550 and 551 on furniture 552), so device 500 exits the continuous object selection session. In some examples, the threshold amount of change is a threshold percentage change to the user-viewable content. For example, the user-viewable content changed by at least 50% between FIGS. 5E and 5F, meaning that at least 50% of the scene of FIG. 5E is no longer in view.

In FIG. 5F, device 500 detects hand gesture input 530 that selects object 550. Because device 500 is not in a continuous object selection session and because device 500 does not detect hand gesture input 530 concurrently with (or within a predetermined duration of) detecting a natural language input, device 500 forgoes performing a task based on selected object 550. For example, in FIG. 5F, device 500 does not provide any output in response to detection of hand gesture input 530.

In FIG. 5G, device 500 concurrently detects hand gesture input 532 that selects object 550 and speech input 534 “remind me to buy more of this.” In response to concurrently detecting hand gesture input 532 and speech input 534, device 500 performs, based on selected object 550, a task requested by speech input 534. For example, device 500 sets a reminder for the user to buy more of object 550 and provides audio output 536 “ok, I'll remind you.”

In FIG. 5G, in response to concurrently detecting hand gesture input 532 and speech input 534, device 500 further initiates a new continuous object selection session. As detailed below with respect to FIG. 5H, during the new continuous object selection session, device 500 selectively performs, without detecting natural language input further to speech input 534, respective instances of the task requested by speech input 534 based on respective objects (e.g., 551) selected by respective user inputs (e.g., 538).

In FIG. 5H, while the new continuous object selection session is initiated, device 500 detects hand gesture input 538 that selects object 551. Device 500 further determines that hand gesture input 538 satisfies the set of input criteria, discussed above. Thus, in response to detecting hand gesture input 538, device 500 initiates, based on object 551, the task requested by previous speech input 534. For example, device 500 sets a reminder for the user to buy more of object 551 and provides audio output 540 “ok, I'll remind you.” Notably, because device 500 detects hand gesture input 538 while the new continuous object selection session is initiated, device 500 does not require a further natural language input (e.g., further to speech input 534) to perform the task based on selected object 551.

Turning to FIGS. 6A-6E, elements 608, 612, 618, and 622 indicate respective gaze locations of the user and are each described as gaze inputs. Elements 608, 612, 618, and 622 are described as gaze inputs for ease of description, though it will be appreciated that the gaze inputs are each in the form of eye tracking data detected by eye tracking device 130. In some examples, elements 608, 612, 618, and 622 are not included in the respective scenes, e.g., the user does not view any of elements 608, 612, 618 and 622.

In FIG. 6A, the scene includes objects 601, 602, 603, and 604 on top of table 605. In FIG. 6A, device 500 concurrently detects speech input 606 and gaze input 608 that selects object 601. In some examples, device 500 detects a gaze input that selects an object by determining that the user's gaze is directed to (e.g., fixated on) the object for a predetermined duration (e.g., 0.05 seconds, 0.1 seconds, 0.2 seconds, 0.5 seconds, or 1 second). In some examples, device 500 concurrently detects speech input 606 and gaze input 608 by detecting that the user gazes at object 601 (e.g., gazes at object 601 for the predetermined duration) while detecting at least a portion of speech input 606, e.g., detects that the user gazes at object 601 between the start and end times of speech input 606.

In FIG. 6A, in response to concurrently detecting speech input 606 and gaze input 608, device 500 initiates a task based on speech input 606 and selected object 601. For example, device 500 identifies object 601 and provides the audio output 610 “this is a red ball.”

In FIG. 6A, in response to concurrently detecting speech input 606 and gaze input 608, device 500 further initiates a continuous object selection session. Like the continuous object selection sessions discussed above with respect to FIGS. 5C-5H, during the continuous object selection session, device 500 selectively performs, without detecting natural language input further to speech input 606, respective instances of the task requested by speech input 606 based on respective objects (e.g., 602) selected by respective user inputs (e.g., 612).

In FIG. 6B, while the continuous object selection session is initiated on device 500, device 500 detects gaze input 612 that selects object 602. In response to detecting gaze input 612, if gaze input 612 satisfies one or more input criteria, device 500 performs, based on object 602, the task requested by speech input 606. If gaze input 612 does not satisfy the one or more input criteria, device 500 forgoes performing the task.

The input criteria are analogous to the input criteria discussed above with respect to FIG. 5D. For example, an input criterion is satisfied when a type of gaze input 612 matches a type of gaze input 608. Thus, gaze input 612 satisfies the input criterion because gaze input 612 and gaze input 608 are both gaze inputs. As another example, an input criterion is satisfied when gaze input 612 is detected before a predetermined duration elapses, e.g., the predetermined duration(s) discussed above with respect to FIG. 5D. As another example, an input criterion is satisfied when gaze input 612 is detected while the continuous object selection session is initiated (e.g., is active) on device 500. As another example, an input criterion is satisfied when objects 601 and 602 are determined to be similar objects.

As another example, an input criterion is satisfied when device 500 interprets gaze input 612 as a selection of object 602. In some examples, device 500 interprets gaze input 612 as a selection of object 602 because, based on gaze input 612, device 500 determines that the user's gaze is fixated on object 602 for a predetermined duration. In some examples, the predetermined duration required for device 500 to interpret gaze input 612 as a selection of object 602 during a continuous object selection session is greater than the predetermined gaze duration otherwise required for device 500 to interpret a gaze input as a selection of a corresponding object. For example, during the continuous object selection session, device 500 performs a task based on object 602 if gaze input 612 corresponds to a user gaze at object 602 for greater than 0.5 seconds. But when device 500 is not in a continuous object selection session, device 500 interprets a gaze input as selection of an object if the gaze input corresponds to a user gaze at the object for greater than 0.25 seconds. Having different predetermined durations for gaze-based object selection may help prevent detection of false positives during the continuous object selection session.

In FIG. 6B, gaze input 612 satisfies the set of input criteria. Thus, in response to detecting gaze input 612, device 500 performs, based on selected object 602, the task requested by previous speech input 606. Specifically, device 500 identifies object 602 and provides audio output 614 “this is a green ball.”

In FIG. 6C, device 500 concurrently detects speech input 616 “levitate this object” and gaze input 618 that selects object 603. Based on detection of speech input 616, device 500 exits the continuous object selection session that was initiated in response to concurrently detecting speech input 606 and gaze input 608 in FIG. 6A. Device 500 exits the continuous object selection session because a session exit criterion is satisfied, specifically because device 500 receives speech input 616 that requests a different task than speech input 606 does. Once device 500 exits the continuous object selection session, device 500 no longer performs the task requested by speech input 606 (e.g., identifying a selected object) in response to inputs that select respective objects.

In FIG. 6C, in response to concurrently detecting speech input 616 and gaze input 618, device 500 initiates a new continuous object selection session. During the new continuous object selection session, as described below with respect to FIGS. 6D-6E, device 500 selectively performs, without detecting natural language input further to speech input 616, respective instances of the task requested by speech input 616 based on respective objects (e.g., 604) selected by respective user inputs (e.g., 622). In FIG. 6C, in response to concurrently detecting speech input 616 and gaze input 618, device 500 further performs, based on selected object 603, the task requested by speech input 616. For example, in FIG. 6D, device 500 alters the appearance of object 603 such that it appears to levitate above table 605.

In FIG. 6D, device 500 remains the in new continuous object selection session. In FIG. 6D, after device 500 performs the task based on object 603, device 500 detects gaze input 622 that selects object 604. Device 500 further determines that gaze input 622 satisfies the set of input criteria as discussed above. Thus, in response to detecting gaze input 622, device 500 performs, based on selected object 604, the task requested by speech input 616. For example, in FIG. 6E, device 500 alters the appearance of object 604 such that it appears to levitate above table 605.

Additional descriptions regarding FIGS. 5A-5H and 6A-6E are provided below in reference to method 700 described with respect to FIG. 7.

FIG. 7 is a flow diagram of a method 700 for performing tasks based on user-selected objects that are present in a three-dimensional scene, according to some examples. In some examples, method 700 is performed at a computer system (e.g., computer system 101 in FIG. 1 and/or device 500) that is in communication with a microphone and one or more sensor devices (e.g., image sensors, light sensors, depth sensors, tactile sensors, orientation sensors, proximity sensors, temperature sensors, location sensors, motion sensors, velocity sensors, and/or biometric sensors). In some examples, method 700 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 700 are distributed across multiple computer systems, e.g., a computer system and a separate server system. Some operations in method 700 are, optionally, combined, the orders of some operations are, optionally, changed, and some operations are, optionally, omitted.

Method 700 includes concurrently detecting (702): a first natural language input (e.g., 516, 534, 606, or 616) via the microphone, wherein the first natural language input requests to perform a first task; and a first input (e.g., an object selection input) (e.g., 518, 532, 608, or 618) via the one or more sensor devices, wherein the first input corresponds to a selection of a first object (e.g., 503, 550, 601, or 603), and wherein the first input is different from the first natural language input.

Method 700 includes: in response to concurrently detecting the first natural language input and the first input, initiating (704) the first task based on the first object (e.g., as illustrated in FIGS. 5C, 5G, 6A, and 6C-6D).

Method 700 includes: after initiating the first task based on the first object: detecting (706), via the one or more sensor devices, a second input (e.g., an object selection input) (e.g., 522, 526, 538, 612, or 622) corresponding to a selection of a second object (e.g., 504, 505, 551, 602, or 604) different from the first object.

Method 700 includes: in response to detecting, via the one or more sensor devices, the second input corresponding to the selection of the second object different from the first object: in accordance with a determination (708) that the second input satisfies a set of input criteria, initiating (710), without receiving (e.g., detecting) a natural language input after detecting the first natural language input (e.g., 516, 534, 606, or 616), the first task based on the second object different from the first object (e.g., as illustrated in FIGS. 5D, 5E, 5H, 6B, and 6D-6E).

Method 700 includes: in response to detecting, via the one or more sensor devices, the second input corresponding to the selection of the second object different from the first object: in accordance with a determination (708) that the second input does not satisfy the set of input criteria, forgoing (712) initiating the first task based on the second object different from the first object (e.g., as illustrated in FIG. 5F).

In some examples, the first input includes a first gesture (e.g., 518 or 532) that is directed to the first object; and the second input includes a second gesture (e.g., 522, 526, or 538) that is directed to the second object. In some examples, the first gesture and/or the second gesture are hand gesture inputs that do not contact (e.g., physically touch) a component (e.g., any component) of the computer system.

In some examples, the first input includes a first user gaze (e.g., 608 or 618) that is directed to the first object; and the second input includes a second user gaze (e.g., 612 or 622) that is directed to the second object.

In some examples, the first input (e.g., an object selection input) includes a combination of gesture input and gaze input, where the computer system interprets the combination of the gesture input and the gaze input as a selection of the first object. For example, the first input includes a gesture input performed while the computer system determines that the user gaze is directed to the first object. In some examples, the second input (e.g., an object selection input) similarly includes a combination of gesture input and gaze input, where the computer system interprets the combination of the gesture input and the gaze input as a selection of the second object.

In some examples, the one or more sensor devices include one or more optical sensors; the first input is detected via the one or more optical sensors; and the second input is detected via the one or more optical sensors.

In some examples, initiating the first task based on the first object includes outputting, based on the first natural language input, information about the first object (e.g., as illustrated in FIGS. 5C and 6A); and initiating the second task based on the second object includes outputting, based on the first natural language input, information about the second object (e.g., as illustrated in FIGS. 5D, 5E and 6B).

In some examples, the first object and the second object are each located within a three-dimensional scene (e.g., the scenes of any of FIGS. 5A-5H and 6A-6E).

In some examples, the set of input criteria includes a first criterion that is satisfied when a type of the first input matches a type of the second input. In some examples, the set of input criteria includes a second criterion that is satisfied when the second input includes a gesture corresponding to a selection of the second object. In some examples, the set of input criteria includes a third criterion that is satisfied when the second input is detected before a first predetermined duration elapses. In some examples, the set of input criteria includes a fourth criterion that is satisfied when the second input is detected while the computer system is set to a gesture recognition mode in which the computer system recognizes hand gestures (e.g., as described with respect to FIGS. 5A-5B).

In some examples, the computer system includes a hardware input component (e.g., 508) (e.g., a button, a switch, a knob, a dial, a touch-sensitive surface, and/or a pressure sensitive surface) and method 700 further includes: detecting a user input (e.g., 510 or 514) (e.g., a touch input, a gesture input, a press input, a rotational input, and/or input that flips a switch) corresponding to a selection of the hardware input component; and in response to detecting the user input corresponding to the selection of the hardware input component, setting the computer system to the gesture recognition mode.

In some examples, the computer system is set to the gesture recognition mode at a first time, and method 700 further includes: while the computer system is set to the gesture recognition mode: in accordance with a determination that a gesture is not detected within a second predetermined duration after the first time, exiting the gesture recognition mode (e.g., as described with respect to FIGS. 5A-5B).

In some examples, method 700 further includes: in response to concurrently detecting the first natural language input and the first input, initiating a session of the computer system (e.g., a continuous object selection session) in which the computer system initiates, based on the first natural language input and without detecting natural language input further to the first natural language input, respective instances of the first task based on respective objects selected by respective user inputs (e.g., as illustrated by FIGS. 5C-5E, 5G-5H, 6A-6B, and 6C-6E). In some examples, the set of input criteria include a fifth criterion that is satisfied when the second input is received while the session of the computer system is initiated.

In some examples, method 700 includes: while the session of the computer system is initiated: in accordance with a determination that a set of session exit criteria is satisfied, exiting the session of the computer system (e.g., as described with respect to FIGS. 5F and 6C). In some examples, method 700 includes: after exiting the session of the computer system: detecting, via the one or more sensor devices, a third input (e.g., 530, 532, or 618) corresponding to a selection of a third object (e.g., 550 or 603); and in response to detecting, via the one or more sensor devices, the third input corresponding to the selection of the third object: in accordance with a determination that the third input is detected concurrently with detecting a second natural language input (e.g., 534 or 616), initiating a second task based on the third object, wherein the second natural language input requests to perform the second task; and in accordance with a determination that the third input is not detected concurrently with detecting a natural language input, forgoing initiating a task based on the third object.

In some examples, the set of session exit criteria include a first exit criterion that is satisfied when a third predetermined duration has elapsed from a time when the computer system last detected a user gesture (e.g., 526). In some examples, method 700 includes detecting, via the one or more sensor devices, image data that represents a scene (e.g., the scene of FIGS. 5E and/or 5F), wherein the set of session exit criteria include a second exit criterion that is satisfied based on the image data that represents the scene. In some examples, method 700 includes while the session of the computer system is initiated, detecting, via the microphone, a third natural language input (e.g., 616), wherein the set of session exit criteria include a third exit criterion that is satisfied when the third natural language input is received.

In some examples, the computer system provides an output (e.g., audio output and/or displayed output) in response to initiating the session of the computer system, where the output indicates that the session of the computer system has been initiated. In some examples, the computer system provides a second output (e.g., audio output and/or displayed output) in response to exiting the session of the computer system, where the second output indicates that the computer system has exited the session. In some examples, the output indicating that the session has been initiated includes an explanation that a further detected object selection input (e.g., 522, 526, 538, 612, or 622) will cause the computer system to initiate a previously requested task based on a newly selected object. In some examples, the computer system provides the output in accordance with a determination that the session of the computer system has been initiated on the computer system fewer than a threshold number of times (e.g., 1 time, 2 times, or 3 times), e.g., to inform the user about such functionality of the computer system.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to perform tasks based on user-selected objects. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to efficiently perform user requested tasks. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of performing tasks for a user, the present technology can be configured to allow users to select to “opt in” or “opt out” of participation in the collection of personal information data during registration for services or anytime thereafter. In another example, users can select not to provide data based on which requested tasks can otherwise be performed. In yet another example, users can select to limit the length of time for which such data is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, tasks can be performed provided based on non-personal information data or a bare minimum amount of personal information, such as the content being requested by the device associated with a user, other non-personal information available to the device, or publicly available information.

What is claimed is:

1. A computer system configured to communicate with a microphone and one or more sensor devices, the computer system comprising:
one or more processors; and
memory storing one or more programs configured to be executed by the one or more processors, the one or more programs including instructions for:
concurrently detecting:
a first natural language input via the microphone, wherein the first natural language input requests to perform a first task; and
a first input via the one or more sensor devices, wherein the first input corresponds to a selection of a first object, and wherein the first input is different from the first natural language input;
in response to concurrently detecting the first natural language input and the first input, initiating the first task based on the first object; and
after initiating the first task based on the first object:
detecting, via the one or more sensor devices, a second input corresponding to a selection of a second object different from the first object; and
in response to detecting, via the one or more sensor devices, the second input corresponding to the selection of the second object different from the first object:
in accordance with a determination that the second input satisfies a set of input criteria, initiating, without receiving a natural language input after detecting the first natural language input, the first task based on the second object different from the first object.

2. The computer system of claim 1, wherein:
the first input includes a first gesture that is directed to the first object; and
the second input includes a second gesture that is directed to the second object.

3. The computer system of claim 1, wherein:
the first input includes a first user gaze that is directed to the first object; and
the second input includes a second user gaze that is directed to the second object.

4. The computer system of claim 1, wherein:
the one or more sensor devices include one or more optical sensors;
the first input is detected via the one or more optical sensors; and
the second input is detected via the one or more optical sensors.

5. The computer system of claim 1, wherein:
initiating the first task based on the first object includes outputting, based on the first natural language input, information about the first object; and
initiating the second task based on the second object includes outputting, based on the first natural language input, information about the second object.

6. The computer system of claim 1, wherein the first object and the second object are each located within a three-dimensional scene.

7. The computer system of claim 1, wherein the set of input criteria includes a first criterion that is satisfied when a type of the first input matches a type of the second input.

8. The computer system of claim 1, wherein the set of input criteria includes a second criterion that is satisfied when the second input includes a gesture corresponding to a selection of the second object.

9. The computer system of claim 1, wherein the set of input criteria includes a third criterion that is satisfied when the second input is detected before a first predetermined duration elapses.

10. The computer system of claim 1, wherein the set of input criteria includes a fourth criterion that is satisfied when the second input is detected while the computer system is set to a gesture recognition mode in which the computer system recognizes hand gestures.

11. The computer system of claim 10, wherein the computer system includes a hardware input component, and wherein the one or more programs further include instructions for:
detecting a user input corresponding to a selection of the hardware input component; and
in response to detecting the user input corresponding to the selection of the hardware input component, setting the computer system to the gesture recognition mode.

12. The computer system of claim 10, wherein the computer system is set to the gesture recognition mode at a first time, and wherein the one or more programs further include instructions for:
while the computer system is set to the gesture recognition mode:
in accordance with a determination that a gesture is not detected within a second predetermined duration after the first time, exiting the gesture recognition mode.

13. The computer system of claim 1, wherein the one or more programs further include instructions for:
in response to concurrently detecting the first natural language input and the first input, initiating a session of the computer system in which the computer system initiates, based on the first natural language input and without detecting natural language input further to the first natural language input, respective instances of the first task based on respective objects selected by respective user inputs.

14. The computer system of claim 13, wherein the set of input criteria include a fifth criterion that is satisfied when the second input is received while the session of the computer system is initiated.

15. The computer system of claim 13, wherein the one or more programs further include instructions for:
while the session of the computer system is initiated:
in accordance with a determination that a set of session exit criteria is satisfied, exiting the session of the computer system; and
after exiting the session of the computer system:
detecting, via the one or more sensor devices, a third input corresponding to a selection of a third object; and
in response to detecting, via the one or more sensor devices, the third input corresponding to the selection of the third object:
in accordance with a determination that the third input is detected concurrently with detecting a second natural language input, initiating a second task based on the third object, wherein the second natural language input requests to perform the second task; and
in accordance with a determination that the third input is not detected concurrently with detecting a natural language input, forgoing initiating a task based on the third object.

16. The computer system of claim 15, wherein the set of session exit criteria include a first exit criterion that is satisfied when a third predetermined duration has elapsed from a time when the computer system last detected a user gesture.

17. The computer system of claim 15, wherein the one or more programs further include instructions for:
detecting, via the one or more sensor devices, image data that represents a scene, wherein the set of session exit criteria include a second exit criterion that is satisfied based on the image data that represents the scene.

18. The computer system of claim 15, wherein the one or more programs further include instructions for:
while the session of the computer system is initiated, detecting, via the microphone, a third natural language input, wherein the set of session exit criteria include a third exit criterion that is satisfied when the third natural language input is received.

19. A method, comprising:
at a computer system that is in communication with a microphone and one or more sensor devices:
concurrently detecting:
a first natural language input via the microphone, wherein the first natural language input requests to perform a first task; and
a first input via the one or more sensor devices, wherein the first input corresponds to a selection of a first object, and wherein the first input is different from the first natural language input;
in response to concurrently detecting the first natural language input and the first input, initiating the first task based on the first object; and
after initiating the first task based on the first object:
detecting, via the one or more sensor devices, a second input corresponding to a selection of a second object different from the first object; and
in response to detecting, via the one or more sensor devices, the second input corresponding to the selection of the second object different from the first object:
in accordance with a determination that the second input satisfies a set of input criteria, initiating, without receiving a natural language input after detecting the first natural language input, the first task based on the second object different from the first object.

20. A non-transitory computer-readable storage medium storing one or more programs configured to be executed by one or more processors of a computer system that is in communication with a microphone and one or more sensor devices, the one or more programs including instructions for:
concurrently detecting:
a first natural language input via the microphone, wherein the first natural language input requests to perform a first task; and
a first input via the one or more sensor devices, wherein the first input corresponds to a selection of a first object, and wherein the first input is different from the first natural language input;
in response to concurrently detecting the first natural language input and the first input, initiating the first task based on the first object; and
after initiating the first task based on the first object:
detecting, via the one or more sensor devices, a second input corresponding to a selection of a second object different from the first object; and
in response to detecting, via the one or more sensor devices, the second input corresponding to the selection of the second object different from the first object:
in accordance with a determination that the second input satisfies a set of input criteria, initiating, without receiving a natural language input after detecting the first natural language input, the first task based on the second object different from the first object.
